(19) United States
(12) Patent Application Publication
(10) Pub. No.: US 2011/0238491 A1
(43) Pub. Date: Sep. 29, 2011

(54) SUGGESTING KEYWORD EXPANSIONS FOR ADVERTISEMENT SELECTION

(75) Inventors: MIKHAIL BILENKO, REDMOND, WA (US); DAVID M. CHICKERING, BELLEVUE, WA (US); HENDRICUS D.J. HOEK, KIRKLAND, WA (US); MATTHEW R. RICHARDSON, SEATTLE, WA (US); DMITRY V. ZHIYANOV, BOTHELL, WA (US)

(73) Assignee: MICROSOFT CORPORATION, REDMOND, WA (US)

(21) Appl. No.: 12/732,820

(22) Filed: Mar. 26, 2010

(51) Int. Cl. G06Q 30/00; G06Q 10/00; G06F 15/18; G06F 17/30

(52) U.S. Cl. 705/14.43; 705/14.54; 707/765; 706/12; 707/E17.017

(57) ABSTRACT

Methods and computer-readable media are provided for receiving keyword expansions from expansion providers and selecting a set of keyword expansions that are used for advertisement selection. Keyword expansions that correspond to a particular search query or text from a browsed web page are received from an expansion provider. Feature data is extracted from each keyword expansion, and may include properties of the keyword expansion or the expansion provider. A score is assigned to each keyword expansion, and based on the score, a set of keyword expansions is selected from the keyword expansions received from the expansion provider. The set of keyword expansions is used to select relevant advertisements for presentation to the user.

### BACKGROUND

Advertisements that are specifically selected based on their relevancy to a user are becoming more and more popular as a way to target a specific audience. For instance, interests of the user may be used for advertisement selection. A search query entered by a user may also be used as a basis for advertisement selection. Even further, text on a web page browsed by a user may be used in advertisement selection. Irrespective of which method is used for advertisement selection, keywords have traditionally been used to match terms in a search query, text, etc., with keywords associated with advertisements. An exact matching of terms may be required in order for a particular advertisement to be selected. Advertisements that are relevant to the user or to the subject matter of interest to the user, as demonstrated by a search query or text of a web page browsed by the user, may not be selected for presentation to the user, however. In some instances, keywords available to select advertisements may not directly match the text of the advertisement or keywords associated with the advertisements, even though the advertisement may be relevant. As such, advertisers may be missing out on valuable opportunities to present their advertisements to users who may have an interest in the product of the advertisement, which could mean lost revenue for the advertiser.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to methods for selecting relevant advertisements based on keyword expansions. Keyword expansions are expansions of a search query, text extracted from a browsed web page, or other original context. A keyword expansion may or may not contain some of the same words as the original context. While typically provided by internal sources, keyword expansions, in embodiments of the present invention, are provided by third-party entities, such as advertisers. As such, in an online or real-time embodiment of the present invention, original context is communicated from a user device to an ad platform, and then to external entities, or expansion providers. The expansion providers communicate one or more keyword expansions that correspond to the original context. Each keyword expansion is associated with feature data that describes properties of the keyword expansion or the expansion provider that submitted the keyword expansion. Importantly, not all of the keyword expansions may be used for advertisement selection. A scoring function assigns a numerical value or score to each keyword expansion, and based on the score, keyword expansions are selected as the most relevant or more useful in advertisement selection.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary computing system architecture configured for use in implementing embodiments of the present invention;

FIG. 3 is a flow diagram of a method for receiving keyword expansions from a third-party expansion provider based on original context received from a user's computing device, in accordance with embodiments of the present invention;

FIG. 4 is a flow diagram of a method for receiving keyword expansions from a third-party expansion provider, in accordance with embodiments of the present invention; and

FIG. 5 is a flow diagram of a method for selecting advertisements based on keyword expansions received from a third-party expansion provider, in accordance with embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention provide for selecting keyword expansions that are thought to be most relevant in selecting advertisements. Keyword expansions are words or phrases that are derived from original context, such as a search query or text from a browsed web page, and may or may not include any of the same words as the corresponding original context. In embodiments of the present invention, keyword expansions are received from expansion providers, which are third parties, such as advertisers. Not all of the keyword expansions may be used for advertisement selection Likewise, not every expansion provider may be trusted, and those keyword expansions suggested by a particular expansion provider may not be selected, such as keyword expansions relating to a certain subject matter. Keyword expansions may be manually selected in one embodiment, or algorithmically selected in another embodiment, such as according to a model. The model, in embodiments, is a selection function trained via machine learning methods, and may include, for example, neural networks, decision trees, support vector machines, etc. Decision trees, for instance, allow the algorithm to learn how to better select keyword expansions and expansion providers based on historical information. In embodiments, an algorithm may assign a score to each keyword expansion based on feature data. Feature data may be provided by the expansion provider, and may include one or more properties of a particular keyword expansion or attributes of the expansion provider that submitted the keyword expansion. Other models may be used and are contemplated to be within the scope of the present invention.

Accordingly, in one aspect, the present invention is directed to one or more computer-readable media storing computer-useable instructions that, when used by one or more computing devices, cause the one or more computing devices to perform a method. The method includes receiving original context from a computing device associated with a user. The original context comprises data used to select advertisements for presentation to the user. The method also includes communicating the original context to at least one expansion provider. The expansion provider is a third party external to an entity that selects advertisements to communicate to various users. At least one keyword expansion is received from the expansion providers. The keyword expansions are based on the original context communicated to the expansion providers. Further, the method includes extracting feature data that is associated with keyword expansions, such as feature data that is sent by the expansion providers. Based on the extracted feature data, a set of keyword expansions is selected from the keyword expansions. The set of keyword expansions is used as a basis for advertisement selection. The method additionally includes utilizing the set of keyword expansions, selecting advertisements, and communicating the advertisements for presentation to the user.

In another aspect, the present invention is directed to one or more computer-readable media storing computer-useable instructions that, when used by one or more computing devices, cause the one or more computing devices to perform a method. The method includes receiving from a first expansion provider a keyword and keyword expansions associated with the keyword. For each of the keyword expansions, feature data is extracted. The feature data comprises an attribute of the keyword expansions or a property of the first expansion provider. Based at least on the extracted feature data, a score is assigned to each of the keyword expansions. The method additionally includes utilizing the scores assigned to the keyword expansions, and selecting a set of keyword expansions from the keyword expansions that are used for advertisement selection.

A further aspect is directed to one or more computer-readable media storing computer-useable instructions that, when used by one or more computing devices, cause the one or more computing devices to perform a method. The method includes receiving a request for advertisements. The request is in a response to one or more of a search query submitted by a user on a search page or the user browsing a web page, and the request includes an original context that includes one or more of the search query submitted by the user, the web page browsed by the user, an identification associated with the user, or a location associated with the user. The method further includes performing an operation on the original context. The operation includes correcting spelling of any alphanumeric strings in the original context, extracting keywords from the search query or text of the web page, or separating the search query or the text of the web page into alphanumeric strings. Further, the method includes communicating the original context to expansion providers. The expansion providers are third parties that are external to an entity that selects advertisements for presentation to the user. Additionally, the method includes receiving from the expansion providers keyword expansions that correspond to the original context, and determining feature data for each of the keyword expansions. The feature data comprises properties associated with a particular keyword expansion or properties of an expansion provider that submitted the particular keyword expansion. A numerical value is assigned to each of the keyword expansions. The numerical value is assigned based on the feature data and a selection function trained via machine learning methods including, for exemplary purposes only, neural networks, decision trees, or support vector machines. The method also includes utilizing the assigned numerical values, selecting a set of keyword expansions from the keyword expansions to use for advertisement selection, selecting advertisements based on the set of keyword expansions, and communicating the advertisements for presentation to the user.

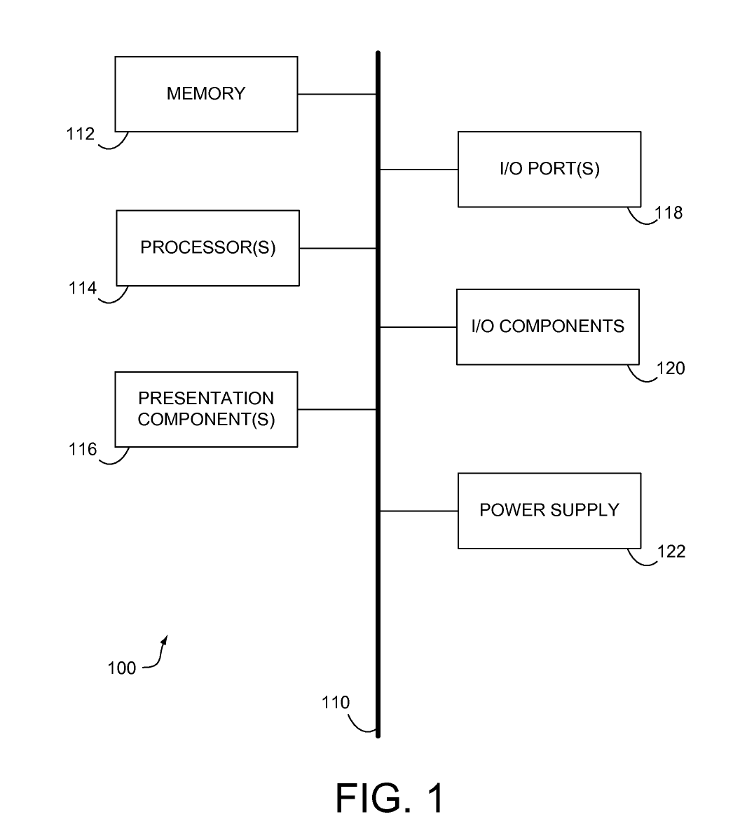

Having briefly described an overview of embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including handheld devices, consumer electronics, general-purpose computers, more specialty computing devices, and the like. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. The bus 110 represents what may be one or more busses (such as an address bus, data bus, or combination thereof). Although the various blocks of FIG. 1 are shown with lines for the sake of clarity, in reality, these blocks represent logical, not necessarily actual, components. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “handheld device,” and the like, as all are contemplated within the scope of FIG. 1 and reference to “computing device.”

The computing device 100 typically includes a variety of computer-readable media. Computer-readable media can be any available media that can be accessed by computing device 100 and includes both volatile and nonvolatile media, removable and non-removable media implemented in any method or technology for storage of information such as computer-readable instructions, data structures, program modules or other data. Computer-readable media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Combinations of any of the above are also included within the scope of computer-readable media.

The memory 112 includes computer-storage media in the form of volatile and/or nonvolatile memory. The memory may be removable, nonremovable, or a combination thereof. Exemplary hardware devices include solid-state memory, hard drives, optical-disc drives, etc. The computing device 100 includes one or more processors that read data from various entities such as the memory 112 or the I/O components 120. The presentation component(s) 116 present data indications to a user or other device. Exemplary presentation components include a display device, speaker, printing component, vibrating component, etc.

The I/O ports 118 allow the computing device 100 to be logically coupled to other devices including the I/O components 120, some of which may be built in. Illustrative components include a microphone, joystick, game pad, satellite dish, scanner, printer, wireless device, and the like.

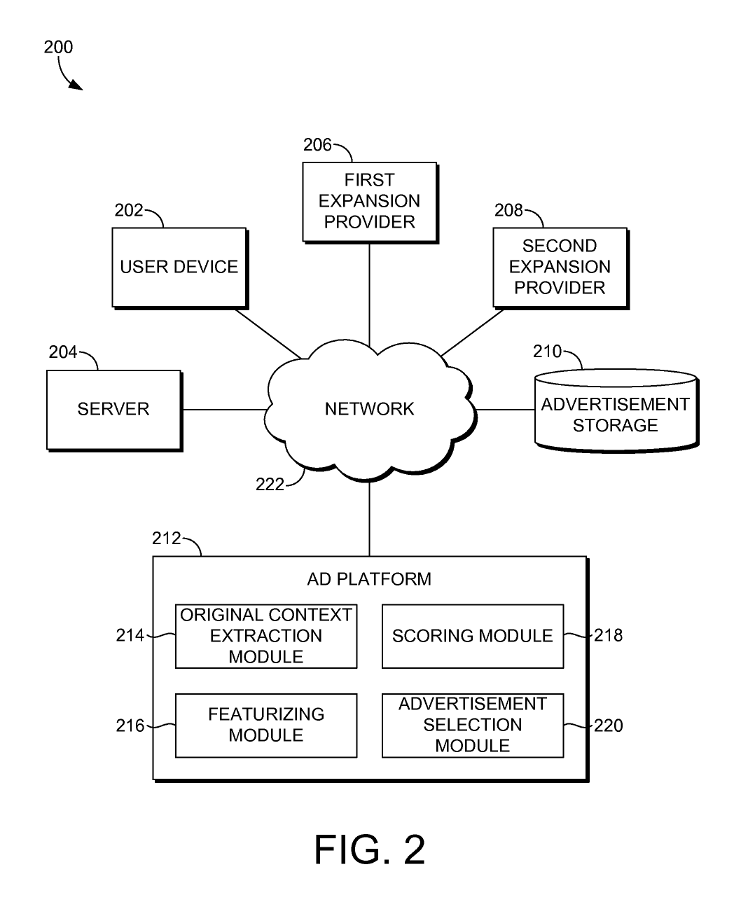

Referring now to FIG. 2, a block diagram is provided illustrating an exemplary system 200 in which embodiments of the present invention may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Among other components not shown, the system 200 includes a user device 202, a server 204, a first expansion provider 206, a second expansion provider 208, an advertisement storage 210, and an ad platform 212. Each of the components shown in FIG. 2 may be any type of computing device, such as computing device 100 described with reference to FIG. 1, for example. The components may communicate with each other via a network 222, which may include, without limitation, one or more local area networks (LANs) and/or wide area networks (WANs). Such networking environments are commonplace in offices, enterprise-wide computer networks, intranets, and the Internet. It should be understood that any number of user devices, servers, expansion providers, advertisement storages, and ad platforms may be employed within the system 200 within the scope of the present invention. Each may comprise a single device or multiple devices cooperating in a distributed environment. For instance, more than one user devices are typically communicating through the network at any one time. Further, one or more expansion providers may be utilized in embodiments of the present invention. Additionally, other components not shown may also be included within the system 200.

A user may communicate with the network 222 through a user device, such as user device 202. The user device 202 may be the type of device described in FIG. 1 with respect to the computing device 100. The user device 202, in one embodiment, provides original context to the ad platform 212 through the network 222. Original context, as used herein, is data that can be used to select advertisements that are communicated to the user for presentation. In one embodiment, a user visits a search engine and submits a search query. The search query is original context. In another embodiment, the user visits any type of web page that would typically display advertisements to the user. Here, the web page, such as text or keywords extracted from the web page, is original context. Original context may also include a user identification, a location of the user, or any other attributes associated with the user (e.g., IP address of the user device 202) that allow for a selection of relevant advertisements.

One or more expansion providers, such as the first expansion provider 206 and the second expansion provider 208, in one embodiment, are third-party entities that submit keyword expansions to the ad platform 212. Instead of receiving keyword expansions from the ad platform itself or the publisher, expansions are received from any entity, which in one embodiment is a third-party entity, but in another embodiment, is an internal entity that normally does not provide keyword expansions. Keyword expansions, as used herein, are variations or extensions of a term or phrase that would typically be used to search for relevant advertisements to present to the user. Keyword expansions are appropriate or relevant words or phrases based on original context. In one instance, keyword expansions are based on a search term entered by a user on a search page. In another instance, keyword expansions are based on text extracted from a web page visited by the user. Additionally, keyword expansions may be based on the user's location or an identification associated with the user that allows for relevant advertisements to be selected. Keyword expansions may contain one or more of the same words as the original context in one embodiment, but in another embodiment, may not necessarily contain any of the same words as the original context. An assumption made is that the intent expressed by the keyword expansions is not necessarily the same intent as the original context, but that the intent is relevant to a user who has entered the search query or who has browsed a particular web page.

In one embodiment, original context communicated by the user device 202 is provided to the expansion providers in real-time, or at the time of advertisement delivery, and the expansion providers then provide keyword expansions based on the original context. For instance, original context of a search term “Canon SLR” is communicated to one or more expansion providers. In real-time, an expansion provider may reply with one or more keyword expansions, such as, for instance, “EOS,” “Revel T1i,” “Canon EF-S,” “Canon cheap,” “best deal on Canon SLR,” etc. But in another embodiment, original context is provided to the expansion providers at a time other than when a user is online and advertisements are to be presented to the user at that time. In this offline embodiment, the expansion providers may not even be provided with original context. Instead, the expansion providers may supply their own keywords, such as terms that they believe will be searched, and along with the search terms, may provide keyword expansions derived from those search terms. In this offline embodiment, when a user enters a search query in a search page, for instance, the third party is not contacted, as relevant keyword expansions have already been received, and real-time consultation with a third-party entity to receive keyword expansions is not necessary. Further, multiple algorithms associated with the expansion providers provide their proposed keyword expansions for expected context. For example, an expansion provider may supply a set of query-phrase pairs for the various queries that the ad platform 212 is expected to be processing in the future. An advertisement storage 210 may include hundreds, thousands, or more of advertisements that are selected based on the expansion keywords. While one advertisement storage 210 is illustrated in FIG. 2, more than one advertisement storages may be used to accomplish embodiments of the present invention.

The ad platform 212 includes several individual components or modules. In addition to those now shown in FIG. 2, these modules include an original context extraction module 214, a featurizing module 216, a scoring module 218, and an advertisement selection module 220. As mentioned above, in an embodiment of the present invention, original context is received from the user device 202, including, for example, a search term or text from a web page that is browsed by the user. Prior to communicating the original context to one or more expansion providers, an original context extraction module 214 may perform one or more operations on the original context, including, but not limited to, checking the spelling of words, extracting keywords from text of a web page, determining whether this particular original context is to be communicated to expansion providers, or the like. The original context extraction module 214 basically acts as an intermediary between the user device 202 and the expansion providers.

Once keyword expansions are provided to the ad platform 212 from the first expansion provider 206 and/or the second expansion provider 208, the featurizing module 216 is responsible for aggregating the keyword expansions and extracting various features from each of the keyword expansions. Features, as used herein, refer to properties associated with a keyword expansion or the expansion provider that provided the keyword expansion. For exemplary purposes only and not limitation, features may include the identity of the expansion provider that provided the keyword expansion, text attributes associated with the keyword expansion, historical statistics corresponding to one or more of the keyword expansion or the expansion provider, a confidence level of the expansion provider as to how confident it is that the suggested keyword expansion is useful in selecting relevant advertisements, a certain geographical location to which the keyword expansion best applies, etc.

Because many keyword expansions may be suggested by one or more expansion providers and some of these keyword expansions may be better than others for selecting relevant advertisements, a selection process may be utilized to select the best keyword expansions based on the corresponding original context. Keyword expansions may be more relevant to determining relevant advertisements if users have historically clicked on or selected those advertisements provided by a particular keyword expansion. Similarly, keyword expansions may be eliminated as not being relevant or useful if users have not historically clicked on or selected those advertisements provided by a particular keyword expansion. Further to this point, not only are some keyword expansions better than others for selecting relevant advertisements, but some expansion providers may also be better than others for submitting the best keyword expansions. Many methods may be utilized to determine the best or most relevant keyword expansions and/or expansion providers. For instance, keyword expansions may be manually selected, or may be selected based on an algorithm Likewise, expansion providers may be selected, based on their reliability, for example, either manually or by way of an algorithm. In one instance, expansion providers are selected as those that are to provide suggested keyword expansions to the ad platform 212. Here, in the case of an online embodiment, these selected expansion providers are provided with original context from which to base suggested keyword expansions. In another instance, however, expansion providers are selected as those from which certain keyword expansions are selected. This may be based on the type of keyword expansion, such as a category of the original context. For instance, if the original context is classified as a sports query, certain expansion providers may be more well-known or better respected in that area, and thus keyword expansions received from those expansion providers may be selected over keyword expansions received from other expansion providers that are not so well-known for sports-type keyword expansions. This is merely one example of how one expansion provider may be preferred over another expansion provider. Other examples are contemplated to be within the scope of the present invention.

As mentioned, algorithms may be employed to carry-out embodiments of the present invention. An algorithmic selection of keyword expansions or expansion providers is based on a model, such as a selection function trained via machine learning methods. These may be based on certain properties of the expansion provider, a certain keyword expansion, and/or the original context. In one embodiment, a scoring module 218 provides a score to keyword expansions, and based on the score, keyword expansions are selected for determining relevant advertisements. A scoring function, in one embodiment, performs selection based on features that encode various properties of each keyword expansion and/or expansion provider. As mentioned, these features may include an identity of the expansion provider, text attributes, historical statistics, etc. An expansion provider may even provide a set of feature values for each submitted keyword expansion. An example of a feature provided by an expansion provider is a level of confidence that the submitted keyword expansion is a good term to use in selecting relevant advertisements. In some instances, an expansion provider may be suggesting a new keyword expansion and may not be completely confident in the success that the keyword expansion will have in determining relevant advertisements. Further, an algorithm may learn that certain expansion providers are overly confident in how relevant their suggested keyword expansions will be, and this over-confidence may be taken into consideration when determining the best keyword expansions. Another example is that historical data is aggregated and used to determine, for instance, that a certain keyword expansion has already been used but has not provided relevant advertisements to present to the user. Thus, next time this keyword expansion is suggested by an expansion provider in relation to a certain original context, such as a search query, an algorithm may know to drop that keyword expansion based on historical data. Even further, keyword expansions received from the first expansion provider 206 may be extremely relevant most of the time, but keyword expansions received from the second expansion provider 208 may not be relevant most of the time. This type of historical data may also be taken into consideration when scoring and selecting the most relevant keyword expansions.

Machine learning methods may be utilized to identify the appropriate scoring function. The scoring module 218, in one embodiment, uses training data, which is typically provided as a set of pairs known as training examples. Each training example includes the items considered for selection, which may include a particular original context and a corresponding keyword expansion or expansion provider. The training example may further include a label, which corresponds to the correct selection decision. Labels can be obtain in multiple ways, including, for instance, explicitly from qualified judges, or implicitly from records of past performance for particular keyword expansions or particular expansion providers. The past performance may be based on various statistics, including, for instance, clicks, revenue, or conversions. The algorithm is able to learn and subsequently set the parameters of the scoring function to minimize some specified loss function, such as accuracy with respect to predicting the labels based on the context and the expansion, as well as the identity of the expansion providers and any additional features.

Learning-based selection of keyword expansions allows for customization of the selection process to optimize desired objectives, which may include exceeding a certain relevance threshold or maximizing expected monetization. The key to such customization is obtaining training data that corresponds to the actual objective being optimized. For instance, if the primary objective is to ensure relevance above a certain threshold, a classifier may be trained on a corpus of context-keyword expansion pairs where judges have provided a corresponding relevance label. As such, the trained classifier is used to select only those expansions for which the scores ensure desired performance with respect to the threshold. Alternatively, if monetization is the desired objective and advertisers are charged per click on their respective advertisements, learning may be based on estimating the expected monetization gain from utilizing each keyword expansion, and selecting those to maximize monetary gain. It should be noted that multiple objectives can be combined, which may require utilizing separate learning systems for each objective, or a single joint learning algorithm for the combined objective.

To further explain how an algorithm would select keyword expansions, suppose that N number of expansion providers are supplying keyword expansions for search advertisements. The set of expansions are denoted from an ith expansion provider for a given query q as Ki(q)={ki1 , . . . , kid}. An expansion provider may optionally provide sets of feature values Fi(q)={Fi1(q), . . . , Fim(i)(q)}, where Fij(q)={vij1, . . . , vijd} is the jth set of feature values for provider i, containing one value per keyword expansion. A scoring function fW(q, K1(q), . . . , KN(q), F1(q), . . . , FN(q)) selects some subset {k1, . . . , kL} of expansions where each ki ∈ K1(q)U . . . U KN(q) is based on a set of parameters W (where W may be learned). Internally, the scoring function may represent each considered keyword expansion ki as a vector of features [e1 . . . eM] that encode various attributes of the keyword expansion, such as the expansion providers suggesting it, arbitrary properties of the query, the keyword expansion, or the pair, or any additional information about other keyword expansions. The scoring function then may use this representation to obtain highest-scoring expansions, which are subsequently used for selecting advertisements.

Once a score has been assigned to the suggested keyword expansions received from one or more expansion providers relating to a particular original context, wherein in one embodiment, the score comprises a numerical value, one of several methods may be utilized to select the keyword expansions that will ultimately be used to determine and select relevant advertisements. For example, a certain number of keyword expansions, such as five keyword expansions having the highest scores may be selected. Or, once scored, those keyword expansions with the top scores are not necessarily selected, but perhaps the keyword expansion with the highest score is selected, then the keyword expansion with the next highest score not having any of the same words as the highest-scoring keyword expansion, and so on. This provides for some diversity in the selected keyword expansions so that they do not all have the same words. In some instances, diversified keyword expansions provide for diversified advertisements. Still yet another method is to disregard the score and select the longest keyword expansions, such as those having the most alphanumeric characters or alphanumeric strings. There are many ways to select keyword expansions, some of which are not described herein. Some are based on a score, and others are based on some other attribute associated with the keyword expansions.

Embodiments of the present invention allow for attributing utility to individual expansion providers. Utility, as used herein, is a function of various performance characteristics, including, but not limited to, relevance, revenue, etc. Most generally, the utility contribution for each provider may be measured as the difference between the overall utility with the expansion provider present, and that without the provider. Such a measurement may be achieved via A/B testing, where for some fraction of the overall traffic, each expansion provider is turned off. Also, expansion providers may choose to be compensated via schemes other than as a function of their contribution to utility, such as flat fees or access to ad platform data, for example. Another method for attributing and testing utility for a particular expansion provider is to poll all advertisers about a particular keyword expansion. The utility function learned from the advertisers can be used, and then it can be determined whether, if the input regarding utility of the keyword expansion, hadn't been received from those advertisers, the algorithm would have marked that keyword expansion as relevant or not.

Using the selected keyword expansions, advertisements may then be selected using the advertisement selection module 220, which in one embodiment, searches for and retrieves in the advertisement storage 210. Before the advertisements are communicated to the user device 202 for presentation to the user, the advertisement selection module 220 or a component therein may filter out any advertisements that are inappropriate for any of a number of reasons, including those with inappropriate words, images, or other graphics, or they may be filtered out based on expected revenue or the advertiser's budget.

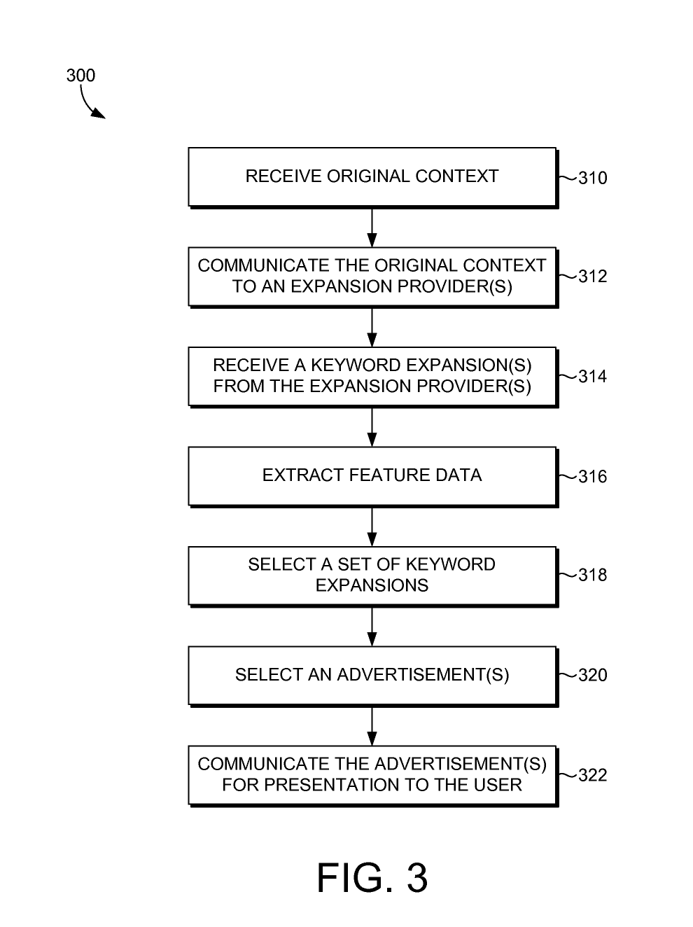

FIG. 3 is a flow diagram of a method 300 for receiving keyword expansions from a third-party expansion provider based on original context received from a user's computing device, in accordance with embodiments of the present invention. Initially, at step 310, original context is received. The original context is received from a computer device, such as the user device 202 described herein in relation to FIG. 2. The original context comprises data that is used to select advertisements for presentation to the user. In one embodiment, the original context is a search query submitted by a user on a search engine. In another embodiment, the original context is text of a web page browsed by the user, wherein the web page is one that would typically display relevant advertisements to the user. In yet other embodiments, the original context may be an identification associated with the user, a location associated with the user, or some other attribute that can be used to provide relevant advertisements to the user. In one embodiment, prior to the original context being communicated to the expansion providers, one or more operations are performed on the original context. These operation include, for exemplary purposes only, correcting spelling of any alphanumeric string in the original context, extracting keywords from the search query or text of the web page, or separating the search query or the text of the web page into one or more alphanumeric strings.

At step 312, the original context is communicated to at least one expansion provider. In embodiments, the expansion provider is a third party external to the entity that is selecting the advertisements to present to the users. For instance, an expansion provider may be an advertisement firm that provides advertisements to the entity that stores and selects advertisements. At least one keyword expansion is received from the expansion providers at step 314. The keyword expansions are based on the original context communicated to the expansion providers. In some instances, keyword expansions contain one or more of the same alphanumeric strings contained in the original context. But in other embodiments, there may be no common alphanumeric strings between the original context and the keyword expansions. As such, the intent of the keyword expression may not be the same as the original context, such as a search query, but the intent of the keyword expression is intended to be relevant to the user who submitted the search query.

Feature data is extracted at step 316. Feature data is associated with the keyword expansion from which it is being extracted. For instance, feature data may be associated with the keyword expansion itself of the expansion provider. As such, feature data may comprise the identity of the expansion provider that submitted a particular keyword expansion. Or, feature data may comprises various properties or attributes of the keyword expansion. For instance, it may include a confidence level of the expansion provider as to how confident the expansion provider is regarding the level of relevance of a particular keyword expansion. At step 318, a set of keyword expansions is selected from the at least one keyword expansions submitted by the expansion providers. The set is selected based on the extracted feature data. Selection of the set of keyword expansions may be manual or algorithmically determined. In the case of an algorithmical determination, a numerical value may be assigned to each of the keyword expansions submitted to the ad platform from the expansion providers. The numerical value is based on, in one embodiment, a quantity of instances that a particular keyword expansion is suggested by the expansion providers. As such, it is assumed that the more instances that a particular keyword expansion is suggested, the more relevant it is in relation to a particular original context. Alternatively, as previously mentioned, the expansion provider may indicate its confidence level in the relevance of a keyword expansion, and this information may be used to assign the numerical value.

At step 320, using the set of keyword expansions, one or more advertisements are selected, and are communicated for presentation to the user at step 322. In one embodiment, the advertisements are communicated to the user device 202 described herein in relation to FIG. 2.

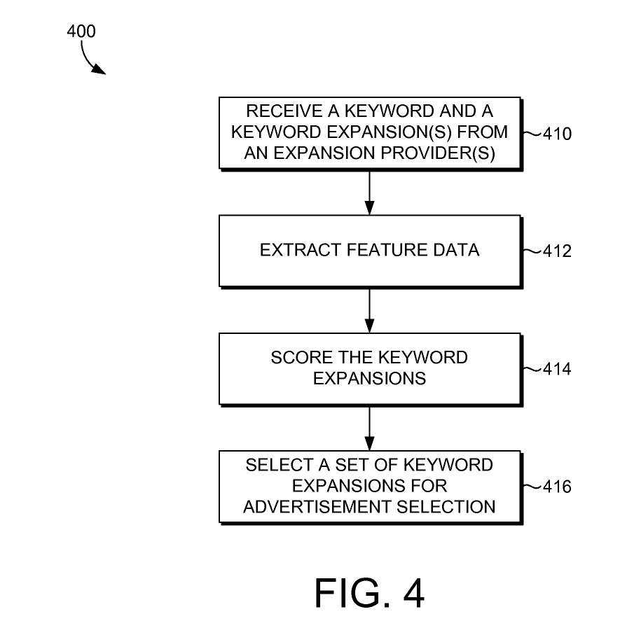

FIG. 4 is a flow diagram of a method 400 for receiving keyword expansions from a third-party expansion provider, in accordance with embodiments of the present invention. At step 410, a keyword and one or more keyword expansions are received from an expansion provider, such as a first expansion provider. At step 412, for each of the keyword expansions received, feature data is extracted. Feature data comprises an attribute of the keyword expansions and/or a property of the first expansion provider. Based on at least the extracted feature data, the keyword expansions are scored at step 414. Using the scores assigned to the keyword expansions, a set of keyword expansions is selected from the one or more keyword expansions at step 416. The set of keyword expansions is used for advertisement selection. The keyword expansions may be selected either manually or by way of an algorithm. In one embodiment, an algorithm uses training data, which provides the algorithm with information regarding how to select the set of keyword expansions. The training data may comprise the keyword, such as the search query of the original context, a keyword expansion, and a label that indicates whether the keyword expansion is relevant in relation to the keyword.

In one embodiment, a first keyword expansion and a second keyword expansion comprise the set of keyword expansions, and are assigned the highest scores. In this embodiment, the highest scoring keyword expansions are selected. In other embodiments, if the second keyword expansion contains any of the same alphanumeric strings as the first keyword expansion, it is not selected so as to provide diversity among the selected keyword expansions. In yet another embodiment, keywords that comprise the original context are categorized into one or more categories by subject matter. Based on historical data, it may be known that certain expansion providers do not provide good or relevant keyword expansions for certain categories. As such, keyword expansions may be received from a second expansion provider. It may be determined that the second expansion provider does not provide relevant keyword expansions for the category to which the keyword belongs. As such, the keyword expansions provided by the second expansion provider are ignored, and not included in the set of keyword expansions used to select advertisements.

Once the set of keyword expansions is selected, one or more advertisements may be selected for presentation to the user. In one instance, the advertisements are presented on a search results page as a result of a user-submitted query. In another instance, the advertisements are presented on a web page that is being browsed by the user.

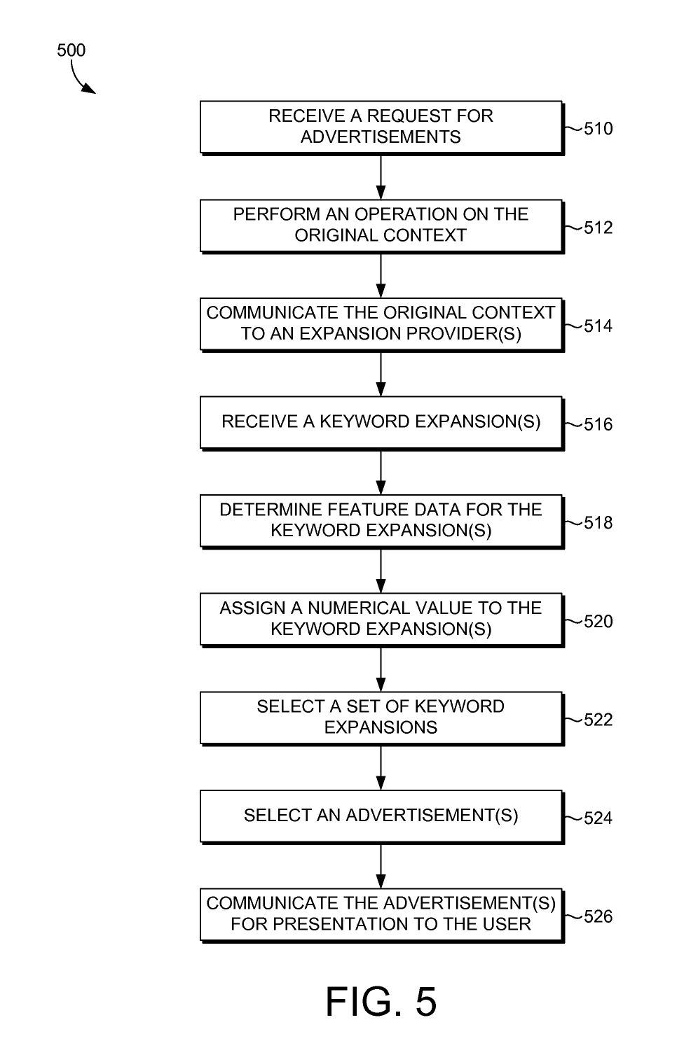

FIG. 5 is a flow diagram of a method 500 for selecting advertisements based on keyword expansions received from a third-party expansion provider, in accordance with embodiments of the present invention. Initially, a request for advertisements is received at 510. The request may be made in response to a query submitted by a user on a search page or the user browsing a web page, wherein the web page is one that typically presents advertisements. The request may include original context, which may be a search query, the web page browsed by the user, an identification associated with the user, or a location associated with the user. Other types of original context are also contemplated to be within the scope of the present invention. At step 512, an operation is performed on the original context. The operation may include one or more of correcting spelling of any alphanumeric strings in the original context, extracting keywords from the search query or text of the web page, or separating the search query or the text of the web page into one or more alphanumeric strings.

At step 514, the original context is communicated to one or more expansion providers. The expansion providers are third parties that are external to the entity that selects advertisements for presentation to the user. One or more keyword expansions that correspond to the original context are received at step 516. The keyword expansions are received from the expansion providers. Feature data is determined for each of the keyword expansions at step 518. The feature data comprises properties associated with a particular keyword expansion or properties of an expansion provider that submitted the particular keyword expansion. At step 520, a numerical value is assigned to each of the keyword expansions based on the feature data and a selection function trained via machine learning methods, including, for instance, neural networks, decision trees, support vector machines, etc. Using the assigned numerical values, a set of keyword expansions is selected from the one or more keyword expansions to use for advertisement selection. This is shown at step 522. At step 524, one or more advertisements are selected based on the set of keyword expansions. The advertisements are communicated for presentation to the user at step 526.

As can be understood, embodiments of the present invention provide for selection of keyword expansions that can be used for advertisement selection. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer-readable media storing computer-useable instructions that, when used by one or more computing devices, cause the one or more computing devices to perform a method comprising:
receiving original context from a computing device associated with a user, wherein the original context comprises data used to select advertisements for presentation to the user;
communicating the original context to at least one expansion provider, wherein the at least one expansion provider is a third party external to an entity that selects advertisements to communicate to various users;
receiving at least one keyword expansion from the at least one expansion provider, wherein the at least one keyword expansion is based on the original context communicated to the at least one expansion provider;
extracting feature data that is associated with the at least one keyword expansion;
based on the extracted feature data, selecting a set of keyword expansions from the at least one keyword expansion, wherein the set of keyword expansions is used as a basis for advertisement selection;
utilizing the set of keyword expansions, selecting one or more advertisements; and
communicating the one or more advertisements for presentation to the user.

2. The one or more computer-readable media of claim 1, wherein the original context includes one or more of a search query submitted by the user, a web page browsed by the user, an identification associated with the user, or a location associated with the user.

3. The one or more computer-readable media of claim 1, further comprising performing one or more operations on the original context, wherein the one or more operations include one or more of correcting spelling of any alphanumeric strings in the original context, extracting keywords from the search query or text of the web page, or separating the search query or the text of the web page into one or more alphanumeric strings.

4. The one or more computer-readable media of claim 1, wherein the at least one keyword expansion contains at least one alphanumeric string that is not contained in the original context.

5. The one or more computer-readable media of claim 1, wherein the keyword expansions that comprise the set of keyword expansions are manually selected.

6. The one or more computer-readable media of claim 1, wherein the keyword expansions that comprise the set of keyword expansions are selected based on a numerical value assigned to each of the at least one keyword expansion.

7. The one or more computer-readable media of claim 6, wherein the numerical value is based on at least a quantity of instances that a particular keyword expansion is suggested by the at least one expansion provider.

8. The one or more computer-readable media of claim 6, wherein the numerical value is based on input from the at least one expansion provider that suggested a particular keyword expansion.

9. The one or more computer-readable media of claim 6, wherein the numerical value is based on historical data associated with previous keyword expansions that have been submitted by the at least one expansion provider.

10. The one or more computer-readable media of claim 9, wherein the historical data indicates a quantity of instances that particular advertisements associated with a particular keyword expansion are selected.

11. The one or more computer-readable media of claim 6, wherein the numerical value is algorithmically determined based on a selection function trained via machine learning methods.

12. One or more computer-readable media storing computer-useable instructions that, when used by one or more computing devices, cause the one or more computing devices to perform a method comprising:
receiving from a first expansion provider a keyword and one or more keyword expansions associated with the keyword;
for each of the one or more keyword expansions, extracting feature data, wherein the feature data comprises one or more of,
1) an attribute of the one or more keyword expansions, or
2) a property of the first expansion provider;
based at least on the extracted feature data, assigning a score to each of the one or more keyword expansions; and
utilizing the scores assigned to the one or more keyword expansions, selecting a set of keyword expansions from the one or more keyword expansions that are used for advertisement selection.

13. The one or more computer-readable media of claim 12, further comprising determining that a first keyword expansion and a second keyword expansion have the highest scores, wherein the first keyword expansion and the second keyword expansion comprise the set of keyword expansions.

14. The one or more computer-readable media of claim 12, wherein the set of keyword expansions comprises a first keyword expansion and a second keyword expansion, and wherein the second keyword expansion does not contain any alphanumeric strings that are contained in the first keyword expansion.

15. The one or more computer-readable media of claim 12, further comprising categorizing the keyword into one or more categories by subject matter.

16. The one or more computer-readable media of claim 15, further comprising:
receiving the one or more keyword expansions from a second expansion provider;
determining, based on historical data, that the second expansion provider does not provide relevant keyword expansions for the category to which the keyword belongs; and
ignoring the one or more keyword expansions received from the second expansion provider.

17. The one or more computer-readable media of claim 12, further comprising selecting one or more advertisements for presentation to the user based on the set of keyword expansions.

18. The one or more computer-readable media of claim 17, wherein the one or more advertisements are presented on a search results page.

19. The one or more computer-readable media of claim 12, wherein each of the one or more keyword expansions are selected based on an algorithm that includes training data that provides the algorithm with information regarding how to select the set of keyword expansions, and wherein the training data comprises the keyword, a member of the one or more keyword expansions, and a label that indicates whether the member of the one or more keyword expansions is relevant in relation to the keyword.

20. One or more computer-readable media storing computer-useable instructions that, when used by one or more computing devices, cause the one or more computing devices to perform a method comprising:
receiving a request for one or more advertisements, wherein the request is in a response to one or more of a search query submitted by a user on a search page or the user browsing a web page, and wherein the request includes an original context that includes one or more of the search query submitted by the user, the web page browsed by the user, an identification associated with the user, or a location associated with the user;
performing at least one operation on the original context, wherein the at least one operation includes one or more of correcting spelling of any alphanumeric strings in the original context, extracting keywords from the search query or text of the web page, or separating the search query or the text of the web page into one or more alphanumeric strings;
communicating the original context to one or more expansion providers, wherein the one or more expansion providers are third parties that are external to an entity that selects advertisements for presentation to the user;
receiving from the one or more expansion providers one or more keyword expansions that correspond to the original context;
determining feature data for each of the one or more keyword expansions, wherein the feature data comprises properties associated with a particular keyword expansion or properties of an expansion provider that submitted the particular keyword expansion;
assigning a numerical value to each of the one or more keyword expansions, wherein the numerical value is assigned based on the feature data and a selection function trained via machine learning methods;
utilizing the assigned numerical values, selecting a set of keyword expansions from the one or more keyword expansions to use for advertisement selection;
selecting one or more advertisements based on the set of keyword expansions; and
communicating the one or more advertisements for presentation to the user.
